(19) United States
(12) Patent Application Publication
(10) Pub. No.: US 2016/0176203 A1
(43) Pub. Date: Jun. 23, 2016

(54) ASSEMBLY FOR PRETREATING AN OBJECT INTENDED TO BE PRINTED WITH AT LEAST ONE INK

(71) Applicant: MACHINES DUBUIT, Noisy le Grand (FR)

(72) Inventors: Jean-Louis Dubuit, Paris (FR); Rui Monteiro, Gagny (FR); Daniel Tronçon, Noisy Le Grand (FR)

(21) Appl. No.: 14/970,779

(22) Filed: Dec. 16, 2015

(30) Foreign Application Priority Data
Dec. 17, 2014 (FR) 14 62643

(51) Int. Cl. B41J 11/00; B05C 11/02

(52) U.S. Cl. CPC B41J 11/0015; B05C 11/02

(57) ABSTRACT

An assembly (15) for pretreating at least one object (5) intended to be printed with at least one ink, the assembly including a frame (34), and at least one pretreatment unit (36) suitable for applying, on a surface (7) of the object, at least one ink adhesion promoter, and obtaining a coated surface (7). The assembly comprises a wiping unit (38) suitable for wiping the coated surface (7) in order to obtain an at least partially wiped surface, the object being in a wiping position in which it is situated across from the wiping unit.

### BACKGROUND OF THE INVENTION

(1) Field of the Invention

The present invention relates to an assembly for pretreating an object intended to be printed with at least one ink, the assembly including:
a frame, and
at least one pretreatment unit suitable for applying, on a surface of the object, at least one ink adhesion promoter, and obtaining a coated surface.

The invention also relates to a printing machine incorporating such a pretreatment assembly, as well as a method corresponding to the pretreatment assembly.

(2) Description of Related Art

In inkjet printing or any other method for printing directly on an object, it is known to treat the surface of the object to be printed before printing in order to improve the adhesion of the ink on the object. In the case of a glass object printed using organic inks dried by UV rays, it is known that the holding of the ink is improved by coating the surface of the glass before printing, for example with a liquid containing silane. Such a liquid is described as adhesion promoter.

Thus, document US 2002/061939 describes a silane-based adhesion promoter added to the printing ink or applied on the object before printing.

In the document filed by the applicants under number FR 13 57831, a chemical pretreatment device is described shown in FIG. 9 associated with an inkjet printing unit. The pretreatment unit comprises an applicator with an adjustable position and incorporating a baize buffer imbibed with chemical product and applied against the portion of the surface of the object to be pretreated. The applicator also includes a dropping pipette making it possible to imbibe the buffer at a suitable flow rate.

Such a pretreatment unit is globally satisfactory. Printing imperfections have, however, sometimes been noted imputable to flaws in the distribution of the ink on the object.

One aim of the invention is therefore to propose an improved pretreatment, which both is an adhesion promoter for the ink later deposited and allows improved quality printing.

### BRIEF SUMMARY OF THE INVENTION

To that end, the invention relates to a pretreatment assembly of the type described above, comprising a wiping unit suitable for wiping the coated surface in order to obtain an at least partially wiped surface, the object being in a wiping position in which the object is situated across from the wiping unit.

According to specific embodiments, the assembly comprises one or more of the following features, considered alone or according to all technically possible combinations:
the assembly further comprises a secondary pretreatment unit, for example by plasma, the assembly being suitable for moving the object from the wiping position to a secondary pretreatment position, in which the object is situated across from the secondary pretreatment unit;
the wiping unit comprises a wiping strip having a part in contact with a portion of the coated surface when the object is in the wiping position, the wiping strip for example being made from a suitable material to leave the portion of the coated surface free of any debris from the material of the wiping strip;
the wiping unit includes:
a chassis mounted on the frame,
a strip holder including a flexible tip, for example made from silicone, the strip holder being mounted on the chassis and the flexible tip being suitable for pressing said part of the wiping strip in a pressing direction against the coated surface,
a conveying system for conveying the wiping strip over the flexible point in a conveying direction in order to renew the part of the wiping strip in contact with the coated surface;
the flexible tip of the strip holder is elongated in a support direction locally parallel to the portion of the coated surface in contact with the wiping strip, the flexible tip having a section, for example V-shaped, perpendicular to the support direction, the section having a shape able to oppose slipping of the wiping strip on the strip support perpendicular to the conveying direction;
the conveying direction and the support direction are substantially parallel to one another;
the strip support includes a carriage translatable relative to the chassis of the wiping unit in the pressing direction, and a jack fastened on the carriage and able to actuate the strip support relative to the carriage in translation in the pressing direction;
the chassis is mounted movably relative to the frame of the translation assembly in a transverse direction, for example perpendicular to the support direction, the wiping unit including a driving system for driving the chassis transversely relative to the frame, the drive system for example including a pinion and a rack;
the pretreatment unit comprises a chassis mechanically secured to the chassis of the wiping unit;
the assembly comprises at least one object holder system designed to hold the object and move the object relative to the frame from a pretreatment position, in which the object is situated across from the pretreatment unit, to at least one other position, which is the wiping position, the pretreatment unit and the wiping unit being separate;
the pretreatment unit and the wiping unit forming a pretreatment and wiping unit, the assembly comprising at least one object holder system designed to hold the object in the wiping position and move the object relative to the frame, the object being designed to be pretreated, then wiped, in the wiping position; and
the pretreatment and wiping unit comprises a reservoir for said adhesion promoter, and is suitable for imbibing the wiping strip of said adhesion promoter, the wiping strip being designed to coat the surface of the object, the conveying system being suitable for renewing the part of the wiping strip in contact with the object after the surface has been coated and before the wiping begins.

The invention also relates to a printing machine comprising:
an assembly as described above to obtain a pretreated surface, and
at least one printing unit suitable for depositing said ink on the surface pretreated by the assembly.

The invention lastly relates to a method for pretreating an object designed to be printed with at least one ink, including at least the following steps:
providing an assembly as described above,
applying, on the surface of the object, via the pretreatment unit, adhesion promoter for the ink, and obtaining the coated surface, and
wiping the coated surface using the wiping unit to obtain an at least partially wiped surface, the object being in the wiping position.

### BRIEF DESCRIPTION OF THE SEVERAL VIEWS OF THE DRAWINGS

The invention and its advantages will be better understood upon reading the following description of two embodiments, provided solely as a non-limiting example and done in reference to the appended drawings, in which:

FIG. 1 is a diagrammatic view of a printing machine according to the invention suitable for printing an object of revolution,

FIG. 2 is a perspective view of the pretreatment assembly of the printing machine shown in FIG. 1, the object holder system being shown diagrammatically in all of the figures,

FIG. 3 is a front view of the pretreatment assembly shown in FIGS. 1 and 2,

FIG. 4 is a left view of the pretreatment assembly shown in FIGS. 1 to 3,

FIG. 5 is a front view of a pretreatment assembly constituting an alternative of that shown in FIGS. 1 to 4, the alternative being suitable for pretreating a substantially flat object,

FIG. 6 is a left view of the pretreatment assembly shown in FIG. 5,

FIG. 7 is a rear view of the pretreatment assembly shown in FIGS. 5 and 6,

FIG. 8 is a partial view of the pretreatment assembly shown in FIGS. 5 to 7, in cross-sectional view in a plane perpendicular to the support direction and passing through a central axis of the object, the flexible tip of the strip support not being pressed against the surface of the object to be printed, and

FIG. 9 is similar to FIG. 8, except that the flexible tip is pressed against the surface of the object to be printed.

### DETAILED DESCRIPTION OF THE INVENTION

Printing Machine

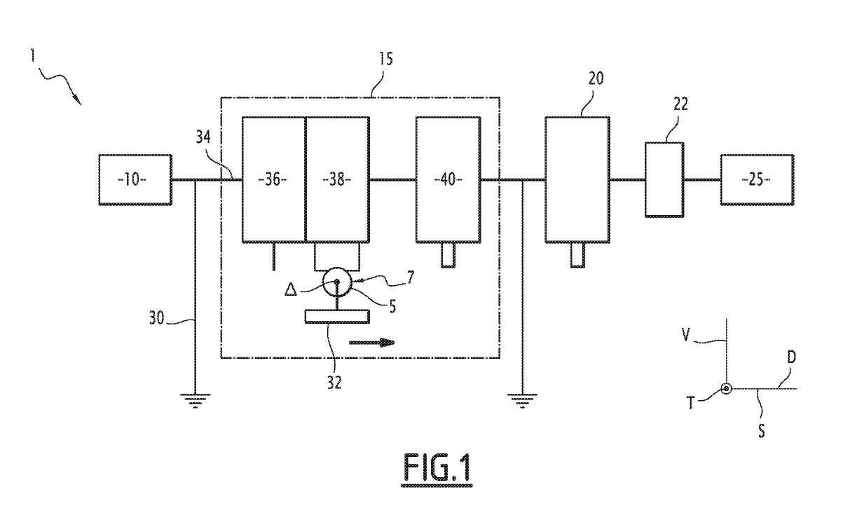

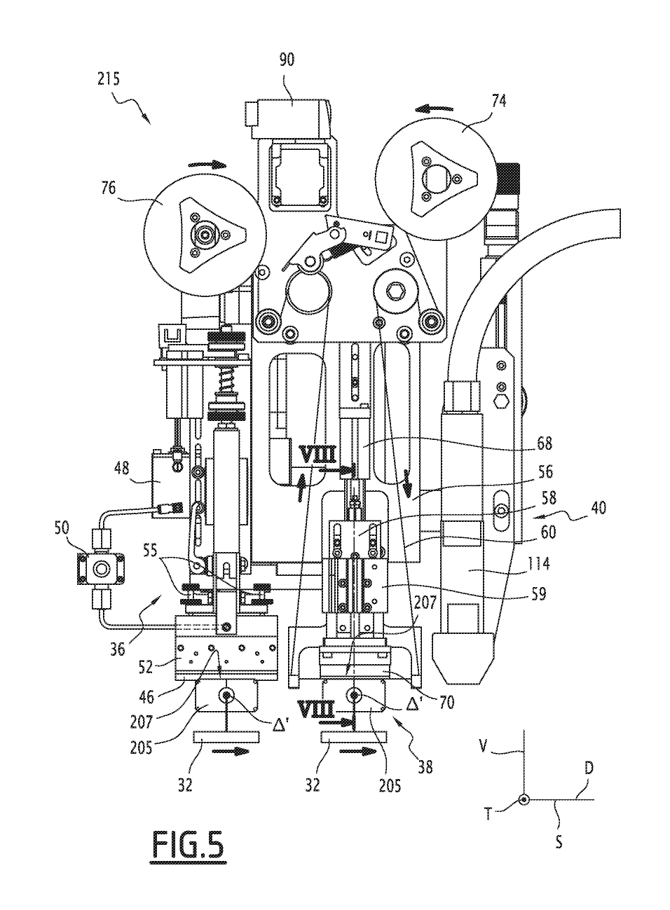

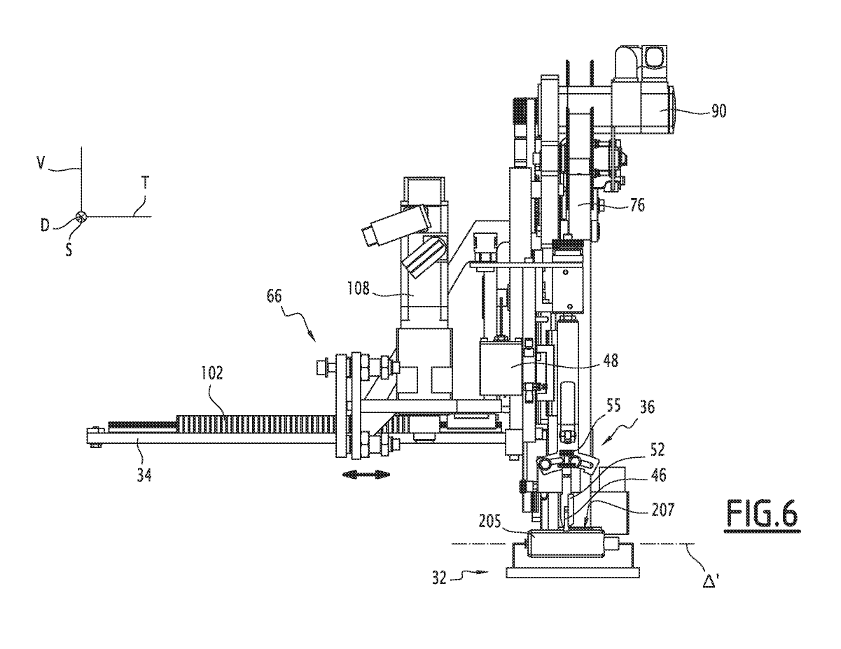

A printing machine 1 according to the invention is described in reference to FIGS. 1 to 4. Occasionally, reference will be made to FIGS. 5 to 8, which pertain to an alternative, for features shared by the printing machine 1 and its alternative shown in FIGS. 5 to 8.

The printing machine 1 is suitable for printing an object 5 of revolution around an axis Δ. “Printing” refers to depositing at least one ink on the object.

Indeed, the printing machine 1 is advantageously able to print, in series, a plurality of objects similar to the object 5 carried by a first conveying system (not shown). The printing machine 1 is next able to deposit the objects after printing on a second conveying system (not shown).

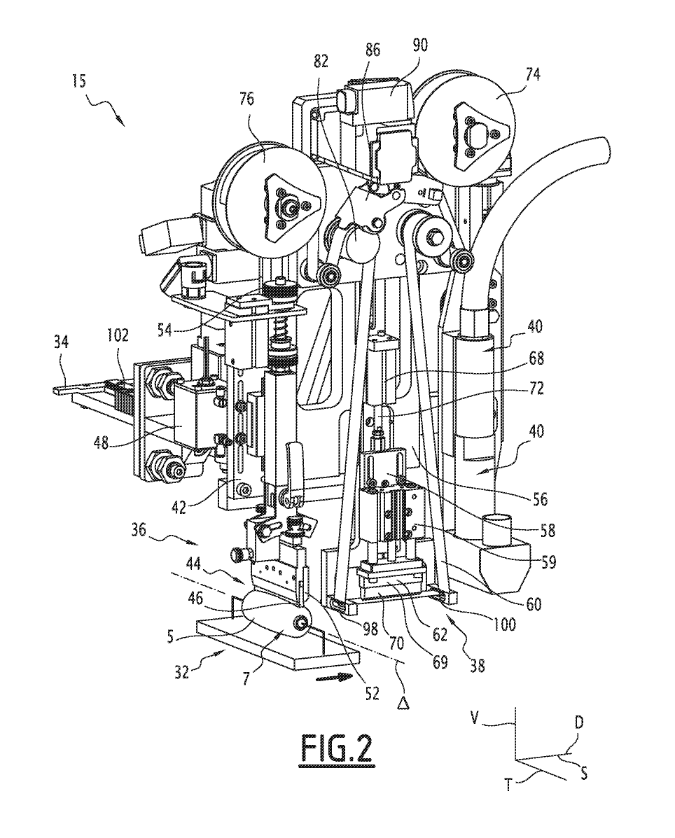

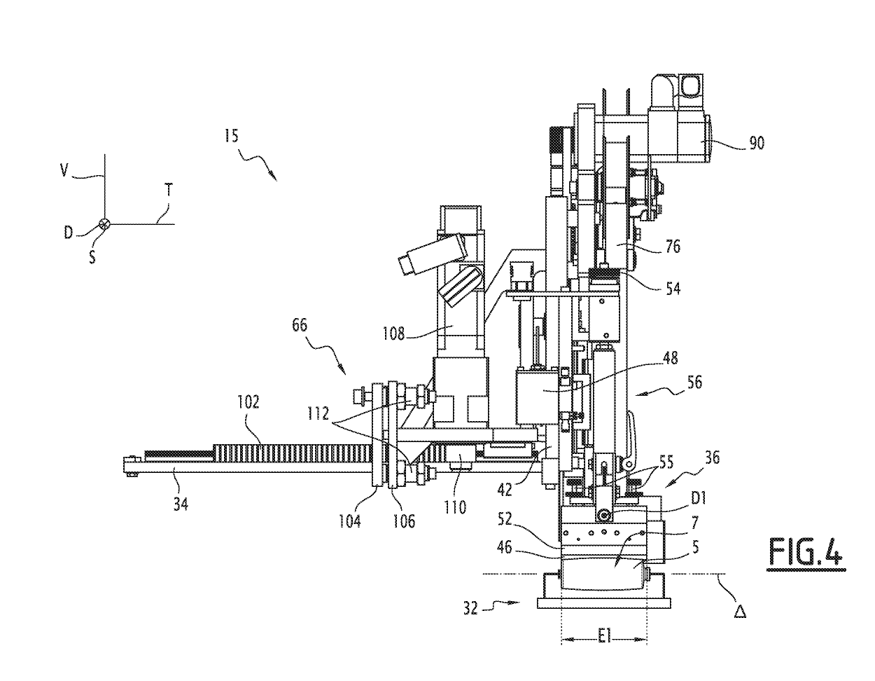

The object 5 is for example a glass bottle. The object 5 includes a surface 7 to be printed, which is convex (FIGS. 2 and 4) in the illustrated example.

Alternatively, the object 5 is cylindrical, or has a concave surface 7.

As shown in FIG. 1, the printing machine 1 successively includes a unit 10 for bringing the object 5, an assembly 15 for pretreating the object, a unit 20 for printing the object, an optional unit 22 for final polymerization of the ink, and a unit 25 for removing the object.

The printing machine 1 also includes a frame 30 on which the units 10, 20, 22, 25 and the assembly 15 are advantageously fixed.

The units 10, 20, 22 and 25 are known in themselves, for example from the aforementioned patent application done by the applicant, and will not be described in detail.

The unit 10 is for example suitable for grasping the object 5 to be printed on the first conveying system and depositing the object on an object holder system 32 of the pretreatment assembly 15.

The unit 20 is a printing unit for example including one or more inkjet print heads, advantageously at least four in order to perform four-color printing.

The unit 25 is for example able to take the object 5 from the object holder system 32 and place the object on the second conveying system.

According to an alternative that is not shown, the printing machine 1 comprises several object holder systems so as to handle several objects at once. This means that one of the objects is presented to any treatment unit of the printing machine 1 by one of the object holder systems, while another of the objects is presented to any other treatment unit of the printing machine by any other of the object holder systems.

As shown in FIGS. 1 to 3, the assembly 15 comprises, aside from the previously mentioned object holder system 32, a frame 34 secured to the frame 30 of the printing machine 1, and a pretreatment unit 36 and wiping unit 38 fixed on the frame 34. Optionally, the assembly 15 also comprises a secondary treatment unit 40, for example by plasma, fixed on the frame 34.

According to an alternative that is not shown, the frame 34 is not mechanically secured to the frame 30, but rests directly on the ground.

The object holder system 32 is for example suitable, as described below, for presenting the object 5 successively to the assembly 15, then to the unit 20, 22.

The object holder system 32 is suitable for successively moving the object 5 relative to the frame 34 from a pretreatment position (FIGS. 2 to 4), in which the object is across from the pretreatment unit 36, to a wiping position (not shown), in which the object is across from the wiping unit 38, then to a secondary pretreatment position (not shown), in which the object is across from the secondary pretreatment unit 40.

The object holder system 32 is for example of the cap-tip type.

The object holder system 32 is able to carry the object 5, in the example by jamming it between the cap and the tip, and advantageously to rotate the object relative to the units 36, 38, 40, 20, 22, respectively, around the axis of revolution Δ.

Pretreatment Unit

The pretreatment unit 36 (FIGS. 2 to 4) comprises a chassis 42, an applicator 44 mounted on the chassis and for example including a baize buffer 46 able to be imbibed with an adhesion promoter of the ink, and a reservoir 48 for this liquid.

The chassis 42 is mounted on the frame 34 in a manner that will be described below.

The reservoir 48 is for example fluidly connected by gravity to a solenoid valve 50 advantageously adjustable by an operator to ensure a drop-by-drop distribution of the liquid to the baize buffer 46.

The buffer 46 is for example gripped in a metal part 52 adjustable relative to the chassis 42 in translation in a pressing direction V, for example vertical, owing to a button 54, for which the baize buffer 46 is in contact with the surface 7 of the object 5 in the pretreatment position.

The adhesion promoter advantageously includes silane, in a proportion for example comprised between 0.15 wt % and 3 wt %, as described for example in document US 2002/061939, and at least one solvent. The solvent is chosen to allow quick drying of the surface 7 coated by the pretreatment unit 36. The solvent is for example alcohol.

The adhesion promoter is for example liquid at ambient temperature, in particular at 20° C.

According to one alternative that is not shown, the adhesion promoter is solid or pasty.

The metal part 52 and the baize buffer 46 are elongated in a transverse direction T substantially perpendicular to the pressing direction V.

The baize buffer 46 has an extension E1 (FIG. 4) in the transverse direction T. The extension E1 is advantageously greater than or equal to the extension of the surface 7 along the axis of revolution Δ of the object 5.

The metal part 52 is advantageously mounted pivoting relative to the chassis 42 around the pivot axis D1 (FIG. 4) and blocked by adjusting screws 55.

The transverse direction T is advantageously substantially parallel to the axis of revolution Δ of the object 5.

Thus, the baize buffer 46 is adjustable relative to the object 5 in the pretreatment position heightwise in the pressing direction V and in parallelism relative to the surface 7 around the pivot axis D1. Advantageously, an incline adjustment is also provided.

Wiping Unit

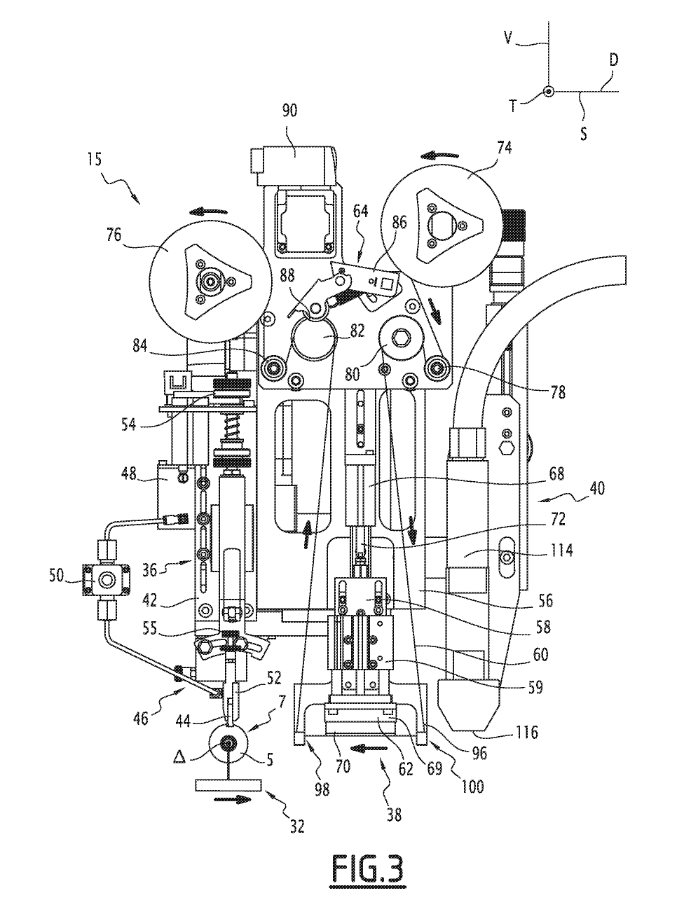

The wiping unit 38 (FIGS. 2 and 3) comprises a chassis 56 mounted moving relative to the frame 34 of the assembly 15 in translation in the transverse direction T, and a carriage 58 translatable in the pressing direction Z relative to the chassis.

The wiping unit 38 also comprises a jack 59 fixed on the carriage 58, a wiping strip 60 suitable for wiping the surface 7, a strip support 62 actuated by the jack 59 relative to the carriage 58 in the pressing direction V, and a conveying system 64 able to convey the wiping strip 60 on the strip support in a conveying direction D.

The wiping unit 38 further comprises a driving system 66 (FIG. 4) for driving the chassis 56 transversely relative to the frame 34, and an actuating system 68 (FIG. 3) of the carriage 58 relative to the chassis 56.

The chassis 56 of the wiping unit 38 and the chassis 42 of the pretreatment unit 36 are for example mechanically secured, and advantageously form a single and same chassis.

The chassis 56 for example substantially extends along the plane P perpendicular to the transverse direction T.

The wiping strip 60 is made from a suitable material to leave the portion of the coated surface 7 free of any debris coming from the material of the wiping strip.

The wiping strip 60 is for example made from an absorbent material that is not fluffy and not rough. The material is for example a fabric.

Alternatively, the material is a nonwoven.

The wiping strip 60 advantageously has a flat width, in a non-stretched state, comprised between 10 mm and 50 mm.

The wiping strip 60 advantageously has a first elasticity in a longitudinal direction and a second elasticity in a transverse direction, the second elasticity being greater than the first elasticity by a factor 10.

The strip support 62 for example comprises a metal support 69 fixed on the jack 59, and a flexible tip 70, advantageously profiled.

The flexible tip 70 is for example made from an elastomeric material, advantageously flexible silicone. Advantageously, the flexible tip 70 has a hardness comprised between 5 and 50 Shore A.

The flexible tip 70 is elongated in a support direction S (FIGS. 2, 3, 4 and 8) and advantageously has a V-shaped cross-section in a plane perpendicular to the support direction.

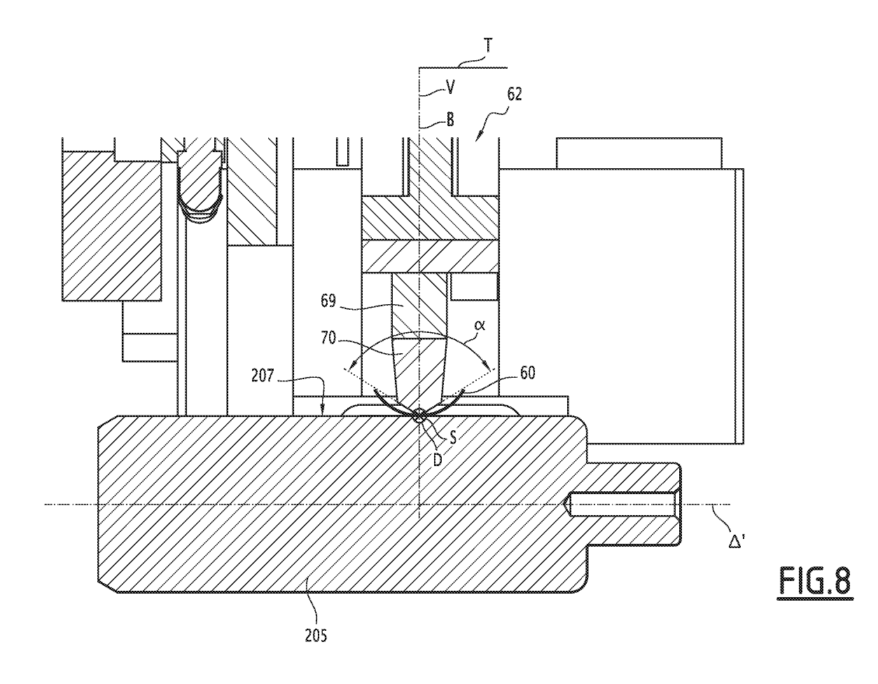

The “V” has a tip oriented toward the object 5 in the wiping position. The “V” for example has an opening angle α (FIG. 8) comprised between 30 and 150 degrees around the support direction S, preferably between 90 and 120 degrees.

The “V” of the flexible tip 70 defines a bisector B (FIG. 8) substantially parallel to the pressing direction V.

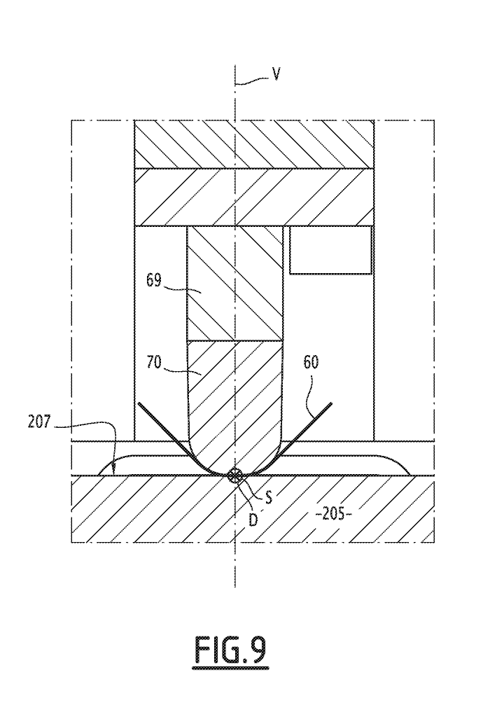

During use, the flexible tip 70 changes shape in contact with the surface 7. The flexible tip 70 then has a round section, as shown in FIG. 9.

The shape of the flexible tip 70 is suitable for opposing slipping of the wiping strip 60 on the strip support 62 perpendicular to the conveying direction D when the wiping strip is stretched on the flexible tip.

The driving system 68 of the carriage 58 for example comprises a jack 72.

The jack 59 is suitable for pressing the flexible tip 70 against the surface 7 of the object 5 when the object 5 is in the wiping position.

According to alternatives that are not shown, one and/or the other of the jacks 59 and 72 are replaced by other types of actuators known in themselves.

The conveying system 64 is suitable for conveying the wiping strip 60 on the flexible tip 70 in a conveying direction D so as to renew the part of the wiping strip 60 in contact with the coated surface 7.

The conveying system 64 comprises a supply coil 74 and a rewinding coil 76. The conveying system 64 comprises, successively in the travel direction of the wiping strip 60, pulleys 78, 80, 82, 84, and an arm 86 including a roller 88 capable of pressing the wiping strip 60 against the pulley 82.

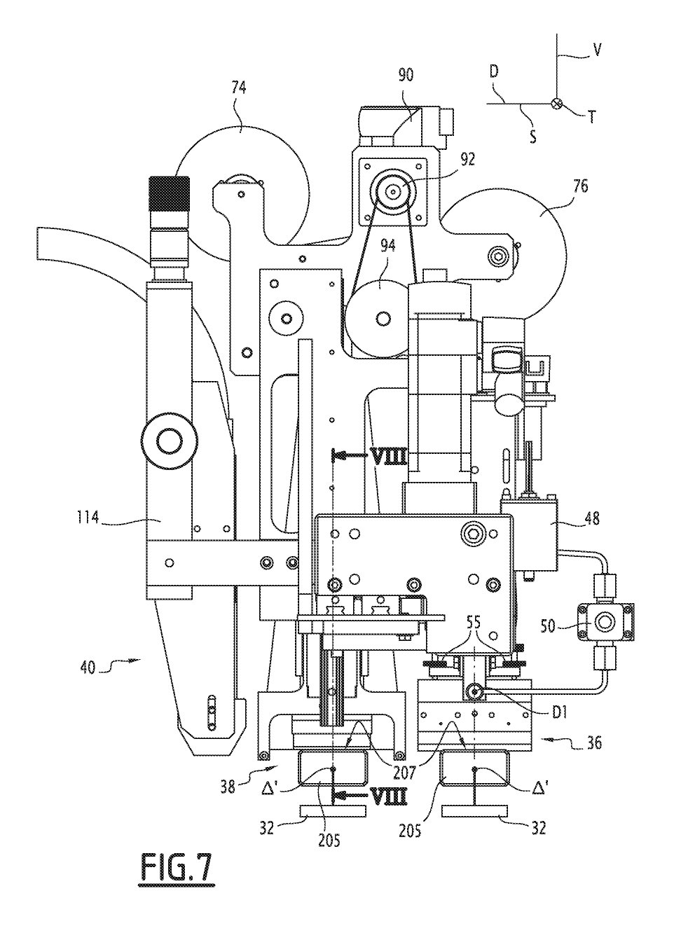

The conveying system 64 also comprises a motor 90 (FIG. 7), a drive pulley 92 rotated by the motor and connected by a belt to a return pulley 94, itself secured to the pulley 82.

The conveying system 64 also comprises a guide 96 (FIG. 3) forming a fork on either side of the flexible tip 70 in the conveying direction D.

The return pulley 94 is connected by a belt to the rewinding coil 76.

The guide 96 is for example secured to the carriage 58.

Each end of the fork respectively includes a surface 98, 100 for supporting and guiding the wiping strip 60 on either side of the flexible tip 70 in the conveying direction D.

From the pulley 80 to the pulley 82, the wiping strip 60 for example follows a trapezoidal path seen in the transverse direction T (FIG. 3).

The supply coil 74, the rewinding coil 76, the pulleys 78, 80, 82, 84, the roller 88, the drive pulley 92 and the return pulley 94 are mounted rotating relative to the chassis 56 around axes for example substantially parallel to the transverse direction T. The drive pulley 92 and the return pulley 94 are situated transversely on the other side of the chassis 56 relative to the pulleys 78, 80, 82, 84.

The conveying direction D is for example substantially combined with the support direction S.

Alternatively (not shown), the conveying direction D is perpendicular to the pressing direction V and forms an angle with the support direction S, advantageously 90° around the pressing direction V.

The drive system 66 comprises a rack 102 mounted sliding transversely relative to the frame 34, and two plates 104, 106 designed to allow adjustment of the parallelism of the strip support 62 with the surface 7. The drive system 66 comprises a servomotor 108 fixed on the frame 34 and including a pinion 110 meshing on the rack 102.

The two plates 104, 106 extend substantially parallel to one another in a plane perpendicular to the transverse direction T. The two plates 104, 106 are connected to one another by aligning screws 112.

The plate 104 is fixed on the rack 102.

The plate 106 is fixed on the chassis 56 of the wiping unit 38.

Secondary Pretreatment Unit

The secondary pretreatment unit 40 comprises a plasma torch 114 for example oriented substantially in the pressing direction V.

Advantageously, the secondary pretreatment unit 40 also has a chassis in common with the chassis 56 of the wiping unit 38.

The plasma torch 114 has an end 116 in the pressing direction V, the end 116 advantageously being situated substantially at the same level in the pressing direction as the flexible tip 70 and the baize buffer 46.

Operation

The operation of the machine 1 will now be described.

In reference to FIG. 1, the unit 10 brings the object 5 from the first conveying system (not shown) to the object holder system 32.

The object holder system 32 carries the object 5 and presents it to the pretreatment unit 36 in the pretreatment position (FIGS. 2 to 4) to subject the object to a pretreatment step. In this position, the baize buffer 46 touches the surface 7 to be pretreated.

Beforehand, the incline of the baize buffer 46 relative to the object 5 around the pivot axis D1 has been adjusted by an operator (not shown). Thus, the baize buffer 46 is inclined so as to hug the surface 7. In the example, the object 5 being quasi-cylindrical, the free edge of the baize buffer 46 is placed substantially parallel to the axis of revolution Δ.

The position of the baize buffer 46 relative to the chassis 42 in the pressing direction V, i.e., the vertical in the example, is adjusted by the operator using the button 54.

The adhesion promoter liquid contained in the reservoir 48 (FIGS. 2 and 3) flows drop by drop in the baize buffer 46. The liquid flow rate is adjusted by the solenoid valve 50 so that the baize 46 is imbibed correctly.

The object carrier system 32 rotates the object 5 relative to the baize buffer 46 around the axis of revolution Δ such that the baize sweeps the surface 7, advantageously over the entire perimeter of the surface around the axis of revolution Δ. A coated surface 7 is thus obtained at the end of the pretreatment step.

Then, the object holder system 32 for example translates in the support direction S toward the wiping unit 38 to place the object 5 in the wiping position to subject the object to the wiping step. The wiping position is therefore deduced by such a translation of the pretreatment position shown in FIG. 3.

The strip support 62 of the wiping unit 38 is lowered by the jack 59. The flexible tip 70 of the strip support 62 presses the wiping strip 60 on the coated surface 7.

During use, the flexible tip 70 goes from the shape illustrated in FIG. 8 to the rounded shape illustrated in FIG. 9.

The object carrier system 32 rotates the object 5 again, this time relative to the flexible tip 70, around the axis of revolution Δ such that the wiping strip 60 sweeps a portion of the coated surface 7.

Concomitantly, the drive system 66 of the wiping unit 38 moves the chassis 56, therefore the flexible tip 70 of the wiping strip 60, transversely relative to the object 5, advantageously continuously.

The portion swept by the wiping strip 60 advantageously has a spiral shape covering the entire coated surface 7.

According to one alternative, the drive system 66 moves the chassis 56 transversely and incrementally each time the object 5 has performed a revolution around the axis of revolution Δ relative to the flexible tip 70. Thus, the swept surface portion 7 is made up of transversely and overlapping successive rings.

Concomitantly with the rotation of the object 5 done by the object holder system 32, the conveying system 64 of the wiping unit 38 causes the wiping strip 60 to be conveyed in contact with the flexible tip 70 and relative to the flexible tip in the conveying direction D, advantageously continuously. Thus, the part of the wiping strip 60 in contact with the coated surface 7 continuously renews itself.

For example, during the wiping, the wiping strip 60 for is conveyed relative to the flexible tip 70 over a distance comprised between ⅙ and one time the diameter of the object 5.

At the end of the wiping step, a partially wiped surface 7 is obtained. “Partially” means that the wiping equalizes the layer of liquid on the surface 7, without completely removing that layer.

The strip support 62 is raised relative to the object 5 by the jack 59.

Next, the object holder system 32 is for example translated in the support direction S toward the secondary pretreatment unit 40 to place the object 5 in the secondary pretreatment position to subject the object to a secondary pretreatment step. The secondary pretreatment position is therefore deduced by such a translation of the wiping position in FIG. 3. As explained above, the secondary treatment is optional.

The object holder system 32 causes the object 5 to rotate around the axis of revolution Δ, this time relative to the end 116 of the plasma torch 114 of the secondary pretreatment unit 40.

Concomitantly with the rotation of the object 5, the drive system 66 of the wiping unit 38 moves the plasma torch 114 transversely relative to the object 5, advantageously continuously.

The plasma sweeps the surface 7 while describing a spiral. The wiped surface 7 is therefore treated with plasma at the end of the secondary pretreatment step. Lastly, the object holder system 32 (or another object holder system in alternatives of the invention) moves the object 5 toward the printing unit 20, where the object 5 undergoes a printing step, for example in four colors, then toward the final polymerization unit 22 to undergo a final polymerization step of the ink.

The unit 25 removes the object 5 from the object holder system 32 and places the object for example on the second conveying system (not shown).

Advantages

Owing to the features described above, the wiping of the coating surface 7 makes it possible to equalize the thickness of the layer of adhesion promoter liquid. Thus, the surface tension forces are more uniform on the surface 7 during the printing step, which reduces or eliminates printing flaws. The pretreatment assembly 15 remains an adhesion promoter for the ink deposited during the printing, because the layer of liquid deposited by the pretreatment unit 36 is not completely removed, the wiping by the wiping unit 38 being partial. The pretreatment assembly 15 is therefore improved relative to the existing assemblies.

Because the material of the wiping strip 60 does not leave debris on the coated surface 7, the printing quality is further improved.

The fact that the wiping strip 60 is set in motion by the conveying system 64 allows an adjustable renewal of the part of the wiping strip in contact with the coated surface 7.

The feature according to which the conveying distance of the wiping strip 60 during the wiping step is comprised between one sixth and one time the diameter of the object 5 allows an optimal renewal of the strip.

The inventors have discovered that the V-shaped flexible tip 70 makes it possible to guide the wiping strip 60 and prevents the latter from slipping on the strip support 62 perpendicular to the conveying direction D during the wiping step.

Owing to the optional feature according to which the pretreatment unit 36, the wiping unit 38 and any secondary pretreatment unit 40 share a same chassis, two actuators are saved to obtain the transverse movements of these units relative to the object 5. The position adjustments relative to the object 5 are also facilitated.

The plates 104, 106 allow a fine adjustment of the orientation, in particular that of the wiping unit 38 relative to the object 5.

First Alternative

In reference to FIGS. 5 to 8, a pretreatment assembly 215 is described constituting a first alternative of the assembly 15 shown in FIGS. 1 to 4.

The assembly 215 is adapted to an object 205 having a substantially planar surface 207, or a large curve radius, for example greater than 100 m. The assembly 205 for example has a rectangular section. The object 205 has an axis Δ′ that is for example an axis of symmetry.

The assembly 215 is structurally practically identical to the assembly 15. The similar elements bear the same numerical references and will not described again. Only the differences, which pertain to geometric and operating features, will be described in detail below.

In the pretreatment unit 36, the metal part 52 and the baize buffer 46 are not elongated in the transverse direction T, but in the support direction S. Relative to the pretreatment unit of the assembly 15, the metal part 52 and the baize buffer 46 are rotated by 90° around the pressing direction Z.

In the pretreatment step, the object holder system 32 does not rotate the object 205 relative to the pretreatment unit 36. The drive system 66 moves the chassis 56, therefore the chassis 42, therefore the baize buffer 46, in translation relative to the object 5 in the transverse direction T, advantageously continuously. Thus, the baize buffer 46 sweeps the surface 207 and coats it with a layer of liquid.

In the wiping step, the object carrier system 32 does not rotate the object 205 relative to the wiping unit 38. The drive system 66 still moves the chassis 56, therefore the flexible tip 70 and the wiping strip 60, transversely relative to the object 5, but the conveying system 64 conveys the wiping unit 60 relative to the flexible tip 70.

Likewise, in the secondary pretreatment step, the object carrier system 32 does not rotate the object 205.

The rest of the operation of the assembly 215 and its advantages are similar to those of the assembly 15.

Furthermore, the optional feature according to which the conveying direction D and the support direction S are substantially combined makes it possible to treat the entire surface 207 of the object 205, even if the surface has an extension in the support direction S greater than the width of the wiping strip 60.

Second Alternative

We will now describe a second alternative (not shown) of the assembly 15. The second alternative is similar to the assembly 15. Only the differences will be described in detail below.

The second alternative differs from the assembly 15 shown in FIGS. 1 and 5 in that the pretreatment unit 36 and the wiping unit form a same treatment and wiping unit 36-38 (not shown, but easily deduced from the units 36 and 38 of the assembly 15).

The object holder 32 does not move the object 5 from a pretreatment unit to a separate wiping unit, relative to the frame 34, but is suitable for keeping the object 5 in the wiping position, in which the object is found across from the treatment and wiping unit 36-38, i.e., across from both the pretreatment unit and the wiping unit.

In this alternative, the pretreatment and wiping unit 36-38 advantageously does not comprise a baize buffer 46. The reservoir 18 is advantageously suitable for imbibing the wiping strip 60. The treatment and wiping unit 36-38 can therefore be seen as the wiping unit 38 of the assembly 15, in which elements of the pretreatment unit 36 have been added, in particular those which make it possible to imbibe the baize 46.

The operation of the second alternative is substantially the same as that of the assembly 15, except that the object carrier 32 places the object 5 directly in the wiping position before the pretreatment step.

The wiping strip 60 is imbibed with the adhesion promoter. The object carrier 32 rotates the object 5 relative to the wiping strip 60 such that the wiping strip sweeps the surface 7, advantageously over the entire perimeter of the surface.

Then, the object 5, which is already in the wiping position, remains in that position. The conveying system 64 conveys the wiping strip 60 so as to renew the part of the wiping strip in contact with the surface 7 of the object 5. It is then a dry, non-imbibed part of the wiping strip 60 that is in contact with the surface 7.

The wiping is next done similarly to that of the assembly 15.

The advantage of the second alternative is on the one hand saving a unit, since the pretreatment unit is combined with the wiping unit to form a mixed unit, and on the other hand saving a movement of the object between two units.

In the case of a cylindrical object, it is still not necessary to apply a force on the wiping strip 60 owing to the flexible tip 70. Indeed, the wiping strip is advantageously applied on the object 5 so as to wind partially on the latter. Consequently, the tension of the wiping strip 60 results in sufficient pressure on the surface 7.

In the case of a flat object, or slightly convex object (such as an oval object or a circular object with a large diameter), an additional pressure force is optionally applied by the flexible tip 70 on the wiping strip 60.

Third Alternative

A third alternative (not shown) is also described, which is an alternative of the assembly 215 shown in FIGS. 5 to 9. The third alternative will not be described in detail.

The third alternative copies the features of merging the pretreatment unit 36 and the wiping unit 38 described above for the second alternative, but applied to the assembly 215.

The object 205 is placed in the wiping position before the pretreatment. For the pretreatment, the wiping strip 60 is imbibed with the adhesion promoter. The drive system 66 makes it possible to coat the surface 207 of the object 205.

Then, the object 2055, which is already in the wiping position, remains in that position. The conveying system 64 conveys the wiping strip 60 so as to renew the part of the wiping strip in contact with the surface 207 of the object 2055.

The wiping is next done similarly to that of the assembly 215.

The advantages of the third alternative are therefore the same as those of the second alternative.

1. An assembly for pretreating at least one object intended to be printed with at least one ink, the assembly including:
a frame, and
at least one pretreatment unit suitable for applying, on a surface of the object, at least one ink adhesion promoter, and obtaining a coated surface;
further comprising a wiping unit suitable for wiping the coated surface in order to obtain an at least partially wiped surface, the object being in a wiping position in which the object is situated across from the wiping unit.

2. The assembly according to claim 1, further comprising a secondary pretreatment unit, for example by plasma, the assembly being suitable for moving the object from the wiping position to a secondary pretreatment position, in which the object is situated across from the secondary pretreatment unit.

3. The assembly according to claim 1, wherein the wiping unit comprises a wiping strip having a part in contact with a portion of the coated surface when the object is in the wiping position.

4. The assembly according to claim 3, wherein the wiping unit includes:
a chassis mounted on the frame,
a strip holder including a flexible tip, the strip holder being mounted on the chassis and the flexible tip being suitable for pressing said part of the wiping strip in a pressing direction against the coated surface,
a conveying system for conveying the wiping strip over the flexible point in a conveying direction in order to renew the part of the wiping strip in contact with the coated surface.

5. The assembly according to claim 4, wherein the flexible tip of the strip holder is elongated in a support direction locally parallel to the portion of the coated surface in contact with the wiping strip, the flexible tip having a section, perpendicular to the support direction, the section having a shape able to oppose slipping of the wiping strip on the strip support perpendicular to the conveying direction.

6. The assembly according to claim 5, wherein the conveying direction and the support direction are substantially parallel to one another.

7. The assembly according to claim 4, wherein the strip support includes a carriage translatable relative to the chassis of the wiping unit in the pressing direction, and a jack fastened on the carriage and able to actuate the strip support relative to the carriage in translation in the pressing direction.

8. The assembly according claim 4, wherein the chassis is mounted movably relative to the frame of the translation assembly in a transverse direction, the wiping unit including a driving system for driving the chassis transversely relative to the frame.

9. The assembly according to claim 4, wherein the pretreatment unit comprises a chassis mechanically secured to the chassis of the wiping unit.

10. The assembly according to claim 1, further comprising at least one object holder system designed to hold the object and move the object relative to the frame (34) from a pretreatment position, in which the object is situated across from the pretreatment unit, to at least one other position, which is the wiping position, the pretreatment unit and the wiping unit being separate.

11. The assembly according to claim 3, wherein the pretreatment unit and the wiping unit form a pretreatment and wiping unit, the assembly comprising at least one object holder system designed to hold the object in the wiping position and move the object relative to the frame, the object being designed to be pretreated, then wiped, in the wiping position.

12. The assembly according to claim 11 wherein the pretreatment and wiping unit comprises a reservoir for said adhesion promoter, and is suitable for imbibing the wiping strip of said adhesion promoter, the wiping strip being designed to coat the surface of the object, the conveying system being suitable for renewing the part of the wiping strip in contact with the object after the surface has been coated and before the wiping begins.

13. A printing machine, comprising:
an assembly for pretreating at least one object intended to be printed with at least one ink, the assembly including:
a frame, and
at least one pretreatment unit suitable for applying, on a surface of the object, at least one ink adhesion promoter, and obtaining a coated surface;
further comprising a wiping unit suitable for wiping the coated surface in order to obtain an at least partially wiped surface, the object being in a wiping position in which the object is situated across from the wiping unit, and
at least one printing unit suitable for depositing said ink on the surface pretreated by the assembly;

14. A method for pretreating an object designed to be printed with at least one ink, including at least the following steps:
providing an assembly for pretreating at least one object intended to be printed with at least one ink,
applying, on the surface of the object, via a pretreatment unit, adhesion promoter for the ink, and obtaining a coated surface, and
wiping the coated surface to obtain an at least partially wiped surface, the object being in a wiping position.

15. The assembly according to claim 1, wherein the wiping strip is made from a suitable material to leave the portion of the coated surface free of any debris from the material of the wiping strip.

16. The assembly according to claim 4, wherein the flexible tip is made of silicone.

17. The assembly according to claim 5, wherein the section of the flexible tip is V-shaped.

18. The assembly according to claim 8, wherein the transverse direction is perpendicular to the support direction.

19. The assembly according to claim 8, wherein the drive system includes a pinion and a rack.
